(19) United States
(12) Patent Application Publication
(10) Pub. No.: US 2026/0005222 A1
(43) Pub. Date: Jan. 1, 2026

(54) SILICON CARBON ANODE ACTIVE MATERIALS FOR LITHIUM-ION BATTERIES

(71) Applicant: Apple Inc., Cupertino, CA (US)

(72) Inventors: Kai Yan, Pleasanton, CA (US); Tsuyonobu Hatazawa, Tokyo (JP); Jia Tang, Cupertino, CA (US); Philaphon Sayavong, Cupertino, CA (US); Louisa Greenburg, Cupertino, CA (US)

(21) Appl. No.: 19/249,929

(22) Filed: Jun. 25, 2025

Related U.S. Application Data
(60) Provisional application No. 63/665,773, filed on Jun. 28, 2024.

(51) Int. Cl. H01M 4/36; H01M 4/02; H01M 4/38; H01M 4/583; H01M 10/0525

(52) U.S. Cl. CPC H01M 4/364; H01M 4/386; H01M 4/583; H01M 10/0525; H01M 2004/021; H01M 2004/027

(57) ABSTRACT

The disclosure is directed to anode active materials containing carbon, silicon, and an additional element, and lithium ion battery cells including the same. The additional element provides a buffer for power loss at low states of charge.

### PRIORITY

This patent application claims the benefit of U.S. Provisional Patent Application No. 63/665,773, entitled “SILICON CARBON ANODE ACTIVE MATERIALS FOR LITHIUM-ION BATTERIES,” filed on Jun. 28, 2024, which is incorporated herein by reference in its entirety.

### FIELD

This disclosure generally relates to batteries, and more particularly, to anode active materials for lithium-ion batteries.

### BACKGROUND

Lithium-ion batteries are used to address the ever-increasing energy demands of a variety of products, including consumer products. Power, and pulsed power over a specific time, provides energy to products throughout the charge of such batteries.

Power capability is highly dependent on the battery state of charge (SoC). In lithium ion batteries having active materials containing alloying anode like silicon provide poor power performance at lower SoC. At very low SoC, the available power can fall precipitously. Providing operating batteries at high voltage at all states of charge is particularly desirable.

### SUMMARY

In a first aspect, the disclosure is directed to an anode active material comprising, carbon, silicon, and an additional element selected from P, As, Sb, Bi, Mg, Zn, Ag, Al, In, Ga, Ge, Sn, Pb, and a combination thereof. In some variations, the additional element is selected from P, As, Sb, Bi, and a combination thereof.

In a second aspect, the ratio of carbon to silicon and the additional element in the anode active material is from 1:9 to 9:1 by volume. In some variations, the ratio of carbon to silicon and the additional element is from 5:5 to 7:3 by volume. In further variations, the amount of carbon is less than or equal to 90 wt % of the total anode active material. In still further variations, the amount of carbon is less than or equal to 85 wt % of the total anode active material. In additional variations, the amount of silicon is at least 10 wt % of the total anode active material. In more specific variations, the amount of silicon is at least 7 wt % of the total anode active material.

In a third aspect, the ratio of silicon to the additional element in the anode active material is from 1:9 to 99:1 by volume. In some variations, the ratio of silicon to the additional element is less than 6:4 by volume. In some variations, the ratio of silicon to the additional element is from 7:3 to 9:1 by volume.

In a fourth aspect, the anode active material comprises a first population of particles having a first average diameter D50 and a second population of particles having a second average diameter D50. In some variations, the first average diameter D50 is from 1 micron to 100 microns. In more specific variations, the first average diameter D50 is from 8 microns to 10 microns. In some variations, the second average diameter D50 is from one eighth to one half of the first particle diameter D50. In more specific variations, the second average diameter D50 is from one fourth to one third of the first particle diameter D50. In some variations, the first population of particles include silicon and the additional element(s). In other variations, the second population of particles include silicon and the additional element(s).

In a fifth aspect, the disclosure is directed to a battery cell having a cathode and an anode. The cathode includes a cathode active material disposed on a cathode current collector. The anode includes the anode active material disposed on an anode current collector.

In some variations, the cathode current collector is aluminum foil. In additional variations, the anode current collector is copper foil. In some variations, the cathode active material is a lithium transition metal oxide. In further variations, the lithium transition metal oxide is a compound of Formula (I):

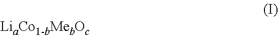

wherein
Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof;

$$0.95 \leq a \leq 1.05 ;$$

$$0 < b \leq 0.5 ; and$$

$$1.95 \leq c \leq 2.05 .$$

In some variations, Me is a single element selected from Na, Si, S, Al, K, V, Cr, Fe, Cu, Zn, Mn, Ni, Zr, La, Ce, Y, Mo, Sn, Ag, Nb, Nu, Ca, Ti, and Mg, then 0<b≤0.15.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell, in accordance with an illustrative embodiment;

FIG. 2 is a side view of a set of layers for a battery cell, in accordance with an illustrative embodiment;

FIG. 3A depicts the measured maximum power (Pmax) as a function of SoC for a battery cell having a pure graphite anode as compared to a 50:50 wt % carbon:wt % silicon anode at each of four temperatures for a pulse duration of 0.1 second, in accordance with an illustrative embodiment;

FIG. 3B depicts the measured maximum power (Pmax) as a function of SoC for a battery cell having a pure graphite anode as compared to a 50:50 wt % carbon:wt % silicon anode at each of four temperatures for a pulse duration of 1.0 second, in accordance with an illustrative embodiment;

FIG. 4 depicts the voltage profile of a battery cell having a silicon containing anode active material as a function of cell capacity and one or more Group (V) additional elements, in accordance with an illustrative embodiment;

FIG. 5A depicts an anode active material including a first population of particles having a first average particle size, in accordance with an illustrative embodiment;

FIG. 5B depicts an anode active material including a first population of particles having a first average particle size and a second population of particles having a second average particle size, in accordance with an illustrative embodiment;

FIG. 6A depicts a comparison of volumetric energy density for batteries containing different anode active materials, in accordance with an illustrative embodiment; and

FIG. 6B depicts a comparison of volumetric capacitance density for batteries containing different anode active materials, in accordance with an illustrative embodiment;

FIG. 7 depicts the voltage as a function of SoC for battery cells having three different anode active materials, in accordance with an illustrative embodiment;

FIG. 8A depicts the E(V) as a function of SoC (%) for anodes lacking the additional element, in accordance with an illustrative embodiment;

FIG. 8B depicts the E(V) as a function of SoC (%) for anodes including Si and the additional element, in accordance with an illustrative embodiment;

FIG. 8C depicts the gain between FIGS. 8B and 8A, as a function of E(V) and the higher % SoC at shutdown voltage, in accordance with an illustrative embodiment;

FIG. 9A depicts the E(V) as a function of SoC (%) for anodes lacking the additional element (in this case bismuth metal), in accordance with an illustrative embodiment;

FIG. 9B depicts the E(V) as a function of SoC (%) for anodes including Si and the additional element bismuth metal, in accordance with an illustrative embodiment;

FIG. 9C depicts the gain between FIGS. 9B and 9A, as a function of E(V) and the higher % SoC at shutdown voltage, in accordance with an illustrative embodiment;

FIG. 9D depicts a comparison of the SoC gain. SoC represents the full capacity of the battery, in accordance with an illustrative embodiment;

FIG. 10A depicts the E(V) as a function of SoC (%) for anodes lacking the additional element (in this case bismuth in the form bismuth oxide), in accordance with an illustrative embodiment;

FIG. 10B depicts the E(V) as a function of SoC (%) for anodes including Si and the additional element bismuth oxide, in accordance with an illustrative embodiment;

FIG. 10C depicts the gain between FIGS. 10B and 10A, as a function of E(V) and the higher % SoC at shutdown voltage, in accordance with an illustrative embodiment;

FIG. 11A depicts the E(V) as a function of SoC (%) for anodes lacking the additional element (in this case antimony), in accordance with an illustrative embodiment;

FIG. 11B depicts the E(V) as a function of SoC (%) for anodes including Si and the additional element antimony, in accordance with an illustrative embodiment; and

FIG. 11C depicts the gain between FIGS. 11B and 11A, as a function of E(V) and the higher % SoC at shutdown voltage, in accordance with an illustrative embodiment.

### DETAILED DESCRIPTION

The following description is presented to allow any person skilled in the art to make and use the embodiments, and is provided in the context of a particular application. Various modifications to the disclosed embodiments will be readily apparent to those skilled in the art, and the general principles defined herein may be applied to other embodiments and applications without departing from the spirit and scope of the present disclosure. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Thus, the disclosure is not limited to the embodiments shown, but is to be accorded the widest scope consistent with the principles and features disclosed herein.

The disclosure provides anode active materials that include one or more additional elements in addition to carbon and silicon. The additional element can serve to support power (e.g., pulse power) at low SoC, thereby reducing brownout risk in high Si anode systems. In some variations, the materials can be provided in two different populations of particles—a first population of particles having first average particle diameter D50 and a second population of particles having a second smaller average particle D50 diameter—to improve the packing density and therefore energy of the system. Particles with the smaller average particle size can be formed of the additional element. Alternatively, particles with the smaller average particle size can be formed of silicon, carbon, or a combination thereof. In a further alternative, the particles with the smaller average particle size can be formed of the additional element, silicon, and carbon. The elements can be mixed together in larger and smaller elements.

A battery cell may be formed by electrodes (e.g., anodes and cathodes), one or more separators, electrolyte, a housing, terminals, and other possible componentry. The battery cell may be employed as a source of power for an electronic device. In certain battery cells, such as certain secondary (e.g., rechargeable) battery cells, the electrodes may be stacked and disposed in a housing (e.g., pouch) of the battery cell.

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode, a separator, and an anode. The stack 102 also includes a separator disposed between the cathode and anode. The cathode, anode, and separator layers may be left flat in a planar configuration or may be wrapped into a wound configuration (e.g., a “jelly roll”).

Battery cells can be enclosed, for example in a flexible pouch or a hard case. Returning to FIG. 1, during assembly of the battery cell 100, the stack 102 can be enclosed in a pouch. The pouch can be flexible or rigid. The stack 102 may be in a planar or wound configuration, although other configurations are possible. If flexible, the pouch can be formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a terrace seal 108. In some variations, the flexible pouch may be less than 120 microns thick to improve the packaging efficiency of the battery cell 100, the density of battery cell 100, or both.

The stack 102 also includes a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack.

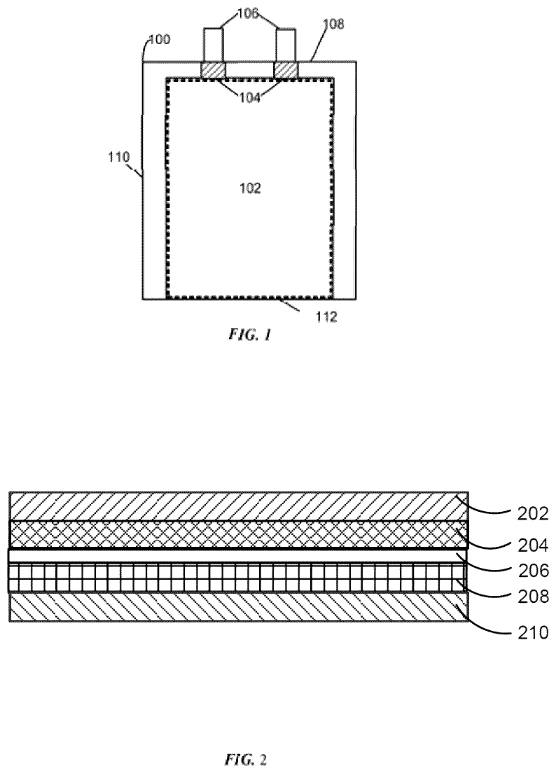

FIG. 2 presents a side view of a set of layers for a battery cell (e.g., the battery cell 100 of FIG. 1) in accordance with the disclosed embodiments. The set of layers may include a cathode current collector 202, a cathode active material 204, a separator 206, an anode active material 208, and an anode current collector 210. The cathode current collector 202 and the cathode active material 204 form a cathode for the battery cell, and the anode current collector 210 and the anode active material 208 form an anode for the battery cell. To create the battery cell, the set of layers may be stacked in a planar configuration, or stacked and then wrapped into a wound configuration.

As mentioned above, the cathode current collector 202 may be aluminum foil, the cathode active material 204 may be a lithium transition metal oxide compound, the anode current collector 210 may be copper foil, and the separator 206 may include a conducting polymer electrolyte.

The anode active materials described herein can be used in conjunction with any battery cells or components thereof known in the art. Battery cell layers may be wound stacked and/or used to form other types of battery cell structures, such as bi-cell structures. All such battery cell structures are known in the art.

In lithium ion batteries that include carbon and silicon anode active materials, power is highly dependent on the state of charge (SoC). When the lithium ion battery is fully charged, Si contributes to high power for device operation. When the amount of Si increases to a blended ratio of 10% Si in a 90% carbon anode by mass (in which Si contributes 50% capacity of the battery), poor power performance at lower states of charge begins to emerge. When the battery state of charge falls below 30-40%, the available power can fall precipitously.

Anode active materials that include one or more additional elements in addition to carbon and silicon provide a “buffer” to loss of power and voltage at low SoC. Selection of the additional element(s) provides a buffer at different voltages. Additionally, the anode active material can include two groups with two different average particle sizes to provide increased packing density.

In one variation, the additional element(s) are selected from P, As, Sb, Bi, Mg, Zn, Ag, Al, In, Ga, Ge, Sn, Pb, and a combination thereof. In another variation, the additional element(s) are selected from Group (V) elements P, As, Sb, Bi, and a combination thereof.

When the element(s) are one or more Group (V) elements, the power as a function of state of charge can have one voltage plateau near 3V. In variations on which the element(s) are selected from Mg, Zn, Ag, Al, In, Ga, Ge, Sn, Pb, and a combination thereof, the power as a function of state of charge can have one or more voltage plateaus above 3V.

In some variations, the additional element is P. In some variations, the additional element is As. In some variations, the additional element is Sb. In some variations, the additional element is Bi. In some variations, the additional element is Mg. In some variations, the additional element is Zn. In some variations, the additional element is Ag. In some variations, the additional element is Al. In some variations, the additional element is In. In some variations, the additional element is Ga. In some variations, the additional element is Ge. In some variations, the additional element is Sn. In some variations, the additional element is Pb. In some variations, the additional elements are any combination of any number of these elements. The additional elements can be in any form, whether as individual elements or as part of a chemical compound.

The carbon can be any carbon source known in the art. In some non-limiting variations, the carbon can be carbon black, graphite, or hard carbon. In more specific variations, the carbon is graphite. In various aspects, the silicon is amorphous silicon, with or without oxygen.

In some variations, the ratio of carbon to silicon and additional element(s) is at least 9:1 by volume. In some variations, the ratio of carbon to silicon and additional element(s) is at least 8:2 by volume. In some variations, the ratio of carbon to silicon and additional element(s) is at least 7:3 by volume. In some variations, the ratio of carbon to silicon and additional element(s) is at least 6:4 by volume. In some variations, the ratio of carbon to silicon and additional element(s) is at least 9:1 by volume. In some variations, the ratio of carbon to silicon and additional element(s) is at least 5:5 by volume. In some variations, the ratio of carbon to silicon and additional element(s) is at least 4:6 by volume. In some variations, the ratio of carbon to silicon and additional element(s) is at least 3:7 by volume. In some variations, the ratio of carbon to silicon and additional element(s) is at least 2:8 by volume. In some variations, the ratio of carbon to silicon and additional element(s) is at least 9:1 by volume. In some variations, the ratio of carbon to silicon and additional element(s) is at least 1:9 by volume.

In some variations, the ratio of carbon to silicon and additional element(s) is less than or equal to 9:1 by volume. In some variations, the ratio of carbon to silicon and additional element(s) is less than or equal to 8:2 by volume. In some variations, the ratio of carbon to silicon and additional element(s) is less than or equal to 7:3 by volume. In some variations, the ratio of carbon to silicon and additional element(s) is less than or equal to 6:4 by volume. In some variations, the ratio of carbon to silicon and additional element(s) is less than or equal to 9:1 by volume. In some variations, the ratio of carbon to silicon and additional element(s) is less than or equal to 5:5 by volume. In some variations, the ratio of carbon to silicon and additional element(s) is less than or equal to 4:6 by volume. In some variations, the ratio of carbon to silicon and additional element(s) is less than or equal to 3:7 by volume. In some variations, the ratio of carbon to silicon and additional element(s) is less than or equal to 2:8 by volume. In some variations, the ratio of carbon to silicon and additional element(s) is less than or equal to 9:1 by volume. In some variations, the ratio of carbon to silicon and additional element(s) is less than or equal to 1:9 by volume.

Any lower boundary of the ratio can be combined with any higher boundary of the ratio in any combination described herein. In some variations, the ratio of Si and additional element(s) to carbon is from 5:5 to 7:3 by volume.

In additional variations, the anode active material includes carbon, silicon, a first additional element selected from P, As, Sb, Bi, Mg, Zn, Ag, Al, In, Ga, Ge, Sn, Pb, and a combination thereof, and a second additional element selected from W, V, Ti, Nb, Fe, P, and a combination thereof. The carbon, silicon, and first additional element are as described herein. In some variations, the ratio of the first additional element to the second additional element is from 1:9 to 9:1 by volume. In some variations, the ratio of the first additional element to the second additional element is from 5:5 to 7:3 by volume.

In some variations, the amount of carbon is at least 99 wt % of the total anode active material. In some variations, the amount of carbon is at least 98 wt % of the total anode active material. In some variations, the amount of carbon is at least 99 wt % of the total anode active material. In some variations, the amount of carbon is at least 97 wt % of the total anode active material. In some variations, the amount of carbon is at least 96 wt % of the total anode active material. In some variations, the amount of carbon is at least 95 wt % of the total anode active material. In some variations, the amount of carbon is at least 94 wt % of the total anode active material. In some variations, the amount of carbon is at least 93 wt % of the total anode active material. In some variations, the amount of carbon is at least 92 wt % of the total anode active material. In some variations, the amount of carbon is at least 91 wt % of the total anode active material. In some variations, the amount of carbon is at least 90 wt % of the total anode active material. In some variations, the amount of carbon is at least 89 wt % of the total anode active material. In some variations, the amount of carbon is at least 88 wt % of the total anode active material. In some variations, the amount of carbon is at least 87 wt % of the total anode active material. In some variations, the amount of carbon is at least 86 wt % of the total anode active material. In some variations, the amount of carbon is at least 85 wt % of the total anode active material.

In some variations, the amount of carbon is less than or equal to 99 wt % of the total anode active material. In some variations, the amount of carbon is less than or equal to 98 wt % of the total anode active material. In some variations, the amount of carbon is less than or equal to 99 wt % of the total anode active material. In some variations, the amount of carbon is less than or equal to 97 wt % of the total anode active material. In some variations, the amount of carbon is less than or equal to 96 wt % of the total anode active material. In some variations, the amount of carbon is less than or equal to 95 wt % of the total anode active material. In some variations, the amount of carbon is less than or equal to 94 wt % of the total anode active material. In some variations, the amount of carbon is less than or equal to 93 wt % of the total anode active material. In some variations, the amount of carbon is less than or equal to 92 wt % of the total anode active material. In some variations, the amount of carbon is less than or equal to 91 wt % of the total anode active material. In some variations, the amount of carbon is less than or equal to 90 wt % of the total anode active material. In some variations, the amount of carbon is less than or equal to 89 wt % of the total anode active material. In some variations, the amount of carbon is less than or equal to 88 wt % of the total anode active material. In some variations, the amount of carbon is less than or equal to 87 wt % of the total anode active material. In some variations, the amount of carbon is less than or equal to 86 wt % of the total anode active material. In some variations, the amount of carbon is less than or equal to 85 wt % of the total anode active material.

Any lower boundary of the wt % of carbon can be combined with any higher boundary of the wt % of carbon in the anode active material in any combination described herein.

In some variations, the amount of the combined Si and additional element(s) is less than or equal to 1 wt % of the total anode active material. In some variations, the amount of the combined Si and additional element(s) is less than or equal to 2 wt % of the total anode active material. In some variations, the amount of the combined Si and additional element(s) is less than or equal to 3 wt % of the total anode active material. In some variations, the amount of the combined Si and additional element(s) is less than or equal to 4 wt % of the total anode active material. In some variations, the amount of the combined Si and additional element(s) is less than or equal to 5 wt % of the total anode active material. In some variations, the amount of the combined Si and additional element(s) is less than or equal to 6 wt % of the total anode active material. In some variations, the amount of the combined Si and additional element(s) is less than or equal to 7 wt % of the total anode active material. In some variations, the amount of the combined Si and additional element(s) is less than or equal to 8 wt % of the total anode active material. In some variations, the amount of the combined Si and additional element(s) is less than or equal to 9 wt % of the total anode active material. In some variations, the amount of the combined Si and additional element(s) is less than or equal to 10 wt % of the total anode active material. In some variations, the amount of the combined Si and additional element(s) is less than or equal to 11 wt % of the total anode active material. In some variations, the amount of the combined Si and additional element(s) is less than or equal to 12 wt % of the total anode active material. In some variations, the amount of the combined Si and additional element(s) is less than or equal to 13 wt % of the total anode active material. In some variations, the amount of the combined Si and additional element(s) is less than or equal to 14 wt % of the total anode active material. In some variations, the amount of the combined Si and additional element(s) is less than or equal to 15 wt % of the total anode active material.

In some variations, the amount of the combined Si and additional element(s) is at least 1 wt % of the total anode active material. In some variations, the amount of the combined Si and additional element(s) is at least 2 wt % of the total anode active material. In some variations, the amount of the combined Si and additional element(s) is at least 3 wt % of the total anode active material. In some variations, the amount of the combined Si and additional element(s) is at least 4 wt % of the total anode active material. In some variations, the amount of the combined Si and additional element(s) is at least 5 wt % of the total anode active material. In some variations, the amount of the combined Si and additional element(s) is at least 6 wt % of the total anode active material. In some variations, the amount of the combined Si and additional element(s) is at least 7 wt % of the total anode active material. In some variations, the amount of the combined Si and additional element(s) is at least 8 wt % of the total anode active material. In some variations, the amount of the combined Si and additional element(s) is at least 9 wt % of the total anode active material. In some variations, the amount of the combined Si and additional element(s) is at least 10 wt % of the total anode active material. In some variations, the amount of the combined Si and additional element(s) is at least 11 wt % of the total anode active material. In some variations, the amount of the combined Si and additional element(s) is at least 12 wt % of the total anode active material. In some variations, the amount of the combined Si and additional element(s) is at least 13 wt % of the total anode active material. In some variations, the amount of the combined Si and additional element(s) is at least 14 wt % of the total anode active material. In some variations, the amount of the combined Si and additional element(s) is at least 15 wt % of the total anode active material.

Any lower boundary of the wt % of silicon and additional element(s) can be combined with any higher boundary of the wt % of carbon in the anode active material in any combination described herein.

In some variations, the ratio of Si to additional element(s) is at least 9:1 by volume. In some variations, the ratio of Si to additional element(s) is at least 8:2 by volume. In some variations, the ratio of Si to additional element(s) is at least 7:3 by volume. In some variations, the ratio of Si to additional element(s) is at least 6:4 by volume. In some variations, the ratio of Si to additional element(s) is at least 9:1 by volume. In some variations, the ratio of Si to additional element(s) is at least 5:5 by volume. In some variations, the ratio of Si to additional element(s) is at least 4:6 by volume. In some variations, the ratio of Si to additional element(s) is at least 3:7 by volume. In some variations, the ratio of Si to additional element(s) is at least 2:8 by volume. In some variations, the ratio of Si to additional element(s) is at least 9:1 by volume. In some variations, the ratio of Si to additional element(s) is at least 1:9 by volume.

In some variations, the ratio of Si to additional element(s) is less than or equal to 9:1 by volume. In some variations, the ratio of Si to additional element(s) is less than or equal to 8:2 by volume. In some variations, the ratio of Si to additional element(s) is less than or equal to 7:3 by volume. In some variations, the ratio of Si to additional element(s) is less than or equal to 6:4 by volume. In some variations, the ratio of Si to additional element(s) is less than or equal to 9:1 by volume. In some variations, the ratio of Si to additional element(s) is less than or equal to 5:5 by volume. In some variations, the ratio of Si to additional element(s) is less than or equal to 4:6 by volume. In some variations, the ratio of Si to additional element(s) is less than or equal to 3:7 by volume. In some variations, the ratio of Si to additional element(s) is less than or equal to 2:8 by volume. In some variations, the ratio of Si to additional element(s) is less than or equal to 9:1 by volume. In some variations, the ratio of Si to additional element(s) is less than or equal to 1:9 by volume.

Any lower boundary of the ratio of Si to additional element(s) can be combined with any higher boundary of the ratio in any combination described herein.

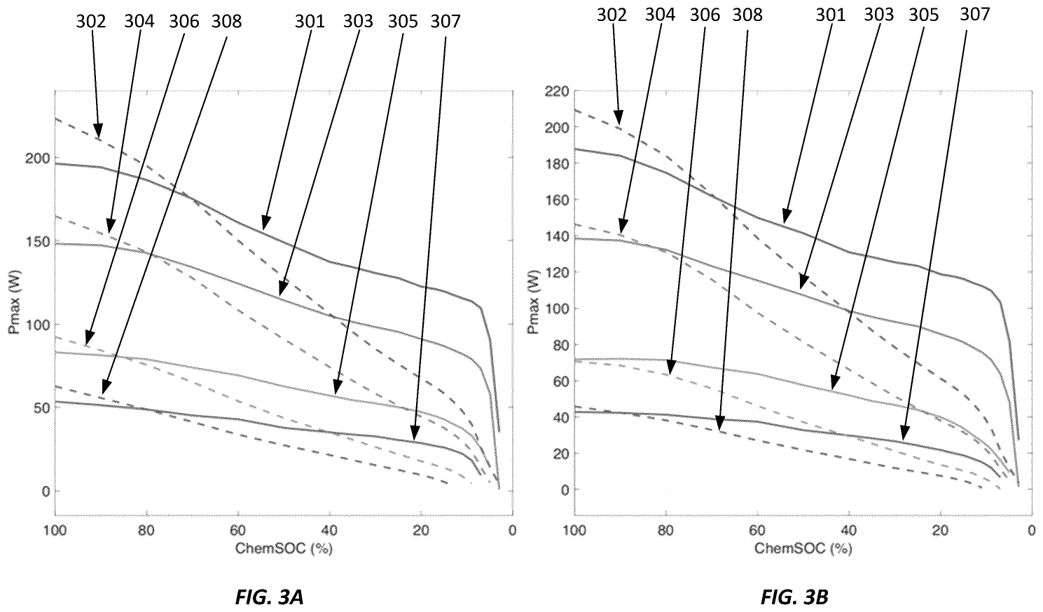

FIGS. 3A and 3B depict the low power capability of high Si cell from 100% to 0% SoC. FIG. 3A depicts the measured maximum power (Pmax) as a function of SoC for a battery cell having a pure graphite anode at four temperatures (301, 303, 305, 307) as compared to a 50:50 wt % carbon:wt % silicon anode at each of four temperatures (302, 304, 306, 308) for a pulse duration of 0.1 second At lower SoC, the Pmax of silicon anodes is higher than the Pmax of graphite anodes in each instance, for every temperature. At 35° C., silicon anode 301 has a higher Pmax than graphite anode 302 above approximately 70% SoC. At 25° C., silicon anode 303 has a higher Pmax than graphite anode 304 above approximately 80% SoC. At 10° C., silicon anode 305 has a higher Pmax than graphite anode 306 above approximately 80% SoC. Likewise, at 0° C., silicon anode 307 has a higher Pmax than graphite anode 308 above approximately 80% SoC.

As depicted in FIG. 3B, silicon anodes provide worse results for longer pulse durations of 1.0 seconds. FIG. 3B depicts the measured maximum power (Pmax) as a function of SoC for a battery cell having a pure graphite anode at four temperatures (solid lines 311, 313, 315, 317) as compared to a 50:50 wt % carbon:wt % silicon anode at each of four temperatures (dashed lines 312, 314, 316, 318) for a pulse duration of 1.0 second. At lower SoC, the Pmax of silicon anodes is higher than the Pmax of graphite anodes in each instance, for every temperature. Like the 0.1 pulse duration depicted in FIG. 3A, at 35° C., silicon anode 311 has a higher Pmax than graphite anode 312 above approximately 70% SoC at a pulse duration of 1.0 second. Likewise, like the 0.1 pulse duration depicted in FIG. 3A, at 25° C. silicon anode 313 has a higher Pmax than graphite anode 314 above approximately 80% SoC. At 10° C., silicon anode 315 has a lower Pmax than graphite anode 316 even at 100% SoC. At 0° C., silicon anode 317 has a higher Pmax than graphite anode 318 at nearly 100% SoC.

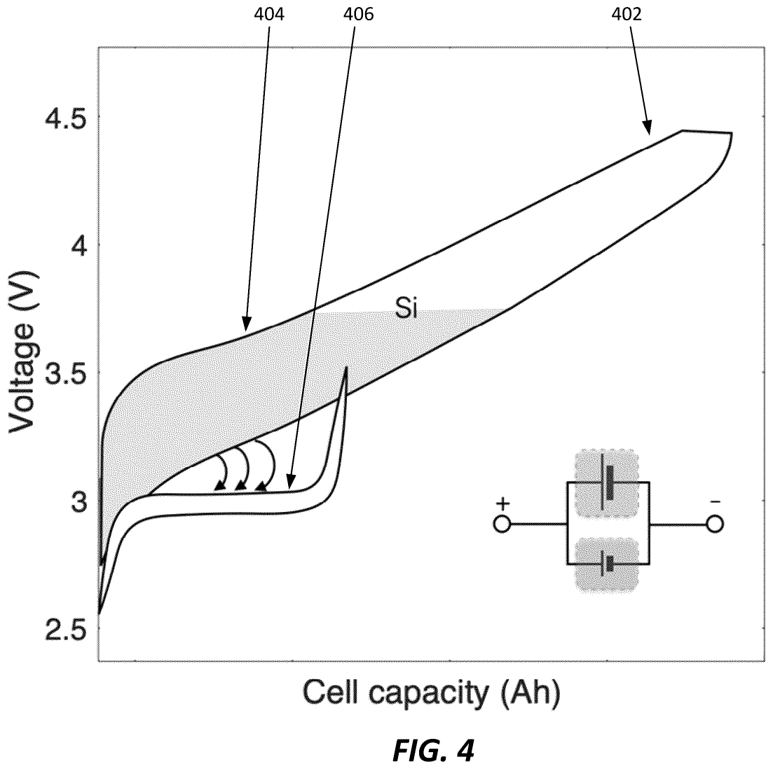

FIG. 4 depicts the voltage profile of a battery cell having a silicon-containing anode active material as a function of cell capacity, and one or more Group (V) additional elements. The peak voltage 402 of battery cells having a silicon-containing anode active material is high at high cell capacities. As the cell capacity falls, the peak voltage of silicon also falls. At low cell capacities 404, voltage falls substantially. On inclusion of one or more additional element(s) in the silicon-containing anode active material, the voltage at low cell capacities is maintained at a plateau of 3V 406, thereby buffering the peak voltage in silicon-containing anode active materials. The path formed by particles of additional elements has a lower resistivity, and is able to provide additional power. Si, a semiconductor with high resistivity, is a slower path which has a higher resistivity.

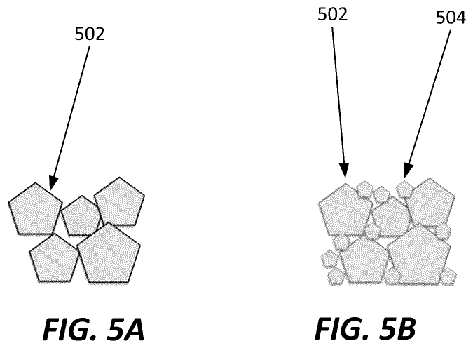

FIG. 5A depicts an anode active material including a first population of particles 502 having a first average particle size. FIG. 5B depicts an anode active material including a first population of particles 502 having a first average particle size, and a second population of particles 504 having a second average particle size. The two populations of particle sizes in FIG. 5B result in increased packing density of the anode active material.

As described herein, particles with the smaller average particle size can be formed of the additional element. In some variations, particles with the smaller average particle size can be formed of the additional particle and silicon. Alternatively, particles with the smaller average particle size can be formed of silicon, carbon, or a combination thereof. In a further alternative, the particles with the smaller average particle size can be formed of the additional element, silicon, and carbon. The elements can be mixed together in any variation.

As described herein, particles with the larger average particle size can be formed of the additional element. In some variations, particles with the larger average particle size can be formed of the additional particle and silicon. Alternatively, particles with the larger average particle size can be formed of silicon, carbon, or a combination thereof. In a further alternative, the particles with the larger average particle size can be formed of the additional element, silicon, and carbon. The elements can be mixed together in any variation.

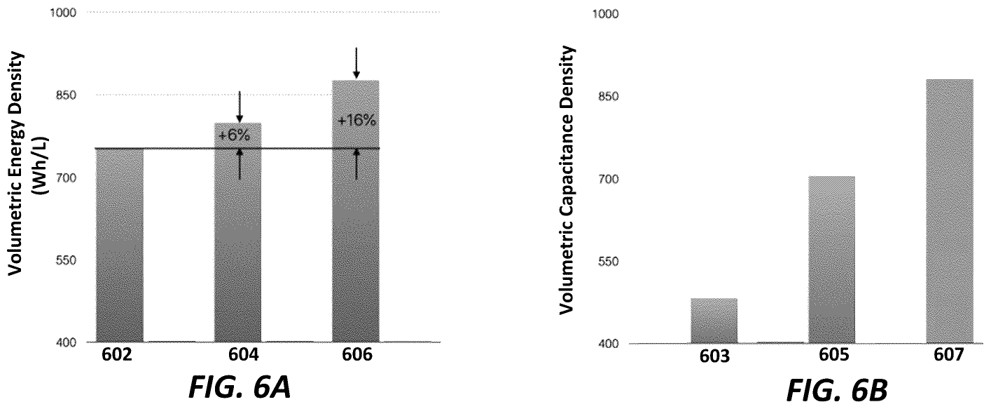

FIG. 6A depicts a comparison of energy density for batteries containing different anode active materials. The energy density 602 of battery cell having an anode active material of pure graphite has a baseline of approximately 730 Wh/L. When the anode active material combines carbon and silicon, the energy density increases by 6%. By adding carbon, silicon, and additional elements in a bimodal distribution, the energy density increases by 16% over anode active materials containing only graphite with a single particle size distribution.

FIG. 6B depicts a comparison of volumetric capacitance density (VCD) of the anode at its thickest state. The VCD 603 of the anode with pure graphite anode active material has a low baseline. When the anode active material combines carbon and silicon, the anode VCD 605 is substantially increased. By adding carbon, silicon, and additional elements in a bimodal distribution, the anode VCD 607 is even more substantially increased.

The first population of particles can have a diameter with a D50 of 1-100 microns. For example, the first population of particles has an average diameter with a D50 of 8-10 microns.

In some variations, the first population of particles has an average diameter D50 of at least 1 micron. In some variations, the first population of particles has an average diameter D50 of at least 2 microns. In some variations, the first population of particles has an average diameter D50 of at least 4 microns. In some variations, the first population of particles has an average diameter D50 of at least 6 microns. In some variations, the first population of particles has an average diameter D50 of at least 6.5 microns. In some variations, the first population of particles has an average diameter D50 of at least 7.0 microns. In some variations, the first population of particles has an average diameter D50 of at least 7.5 microns. In some variations, the first population of particles has an average diameter D50 of at least 8 microns. In some variations, the first population of particles has an average diameter D50 of at least 10 microns. In some variations, the first population of particles has an average diameter D50 of at least 20 microns. In some variations, the first population of particles has an average diameter D50 of at least 40 microns. In some variations, the first population of particles has an average diameter D50 of at least 60 microns. In some variations, the first population of particles has an average diameter D50 of at least 80 microns.

In some variations, the first population of particles has an average diameter D50 of less than or equal to 2 microns. In some variations, the first population of particles has an average diameter D50 of less than or equal to 4 microns. In some variations, the first population of particles has an average diameter D50 of less than or equal to 6 microns. In some variations, the first population of particles has an average diameter D50 of less than or equal to 6.5 microns. In some variations, the first population of particles has an average diameter D50 of less than or equal to 7.0 microns. In some variations, the first population of particles has an average diameter D50 of less than or equal to 7.5 microns. In some variations, the first population of particles has an average diameter D50 of less than or equal to 8 microns. In some variations, the first population of particles has an average diameter D50 of less than or equal to 10 microns. In some variations, the first population of particles has an average diameter D50 of less than or equal to 20 microns. In some variations, the first population of particles has an average diameter D50 of less than or equal to 40 microns. In some variations, the first population of particles has an average diameter D50 of less than or equal to 60 microns. In some variations, the first population of particles has an average diameter D50 of less than or equal to 80 microns. In some variations, the first population of particles has an average diameter D50 of less than or equal to 100 microns.

Any lower boundary of the first population of particle average diameter D50 can be combined with any higher boundary of the second population of particle diameter average D50 in any combination described herein.

The first population of particles can have a diameter with a D50 of 1-100 microns. For example, the first population of particles has an average diameter with a D50 of 8-10 microns.

In some variations, the second population of particles has an average diameter D50 of at least one eighth of any of the averaged diameter D50 of the first population of particles. In some variations, the second population of particles has an average diameter D50 of at least one quarter of any of the averaged diameter D50 of the first population of particles. In some variations, the second population of particles has an average diameter D50 of at least one third of any of the averaged diameter D50 of the first population of particles. In some variations, the second population of particles has an average diameter D50 of at least one half of any of the averaged diameter D50 of the first population of particles.

In some variations, the second population of particles has an average diameter D50 of less than or equal to one eighth of any of the averaged diameter D50 of the first population of particles. In some variations, the second population of particles has an average diameter D50 of less than or equal to one quarter of any of the averaged diameter D50 of the first population of particles. In some variations, the second population of particles has an average diameter D50 of less than or equal to one third of any of the averaged diameter D50 of the first population of particles. In some variations, the second population of particles has an average diameter D50 of less than or equal to one half of any of the averaged diameter D50 of the first population of particles.

Any lower boundary of the particle average diameter D50 can be combined with any higher boundary of the particle diameter average D50 in any combination described herein.

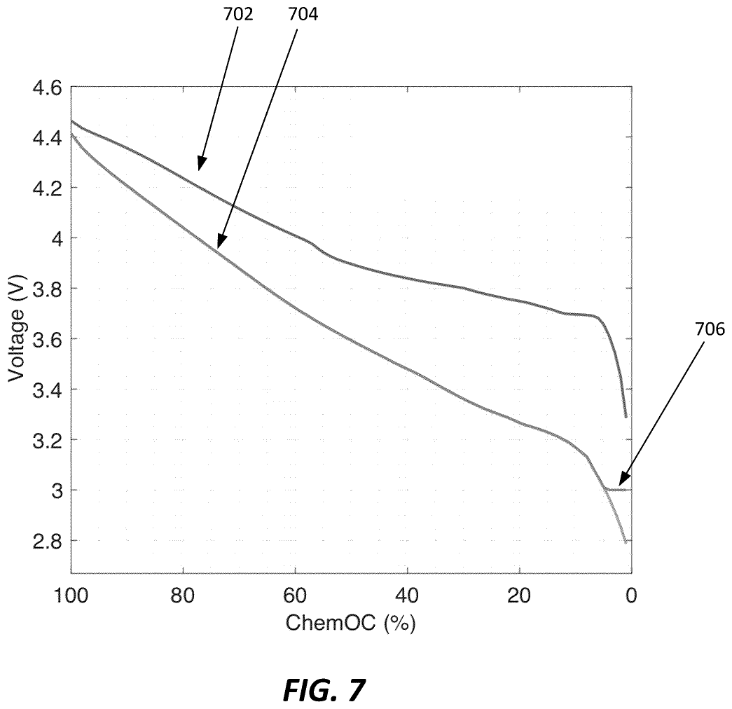

FIG. 7 depicts the voltage as a function of SoC for battery cells having three different anode active materials. Voltage profile 702 corresponds to battery cells having an anode active material of only graphite. The voltages remain high as a function of SoC before falling precipitously at approximately 6% SoC. Voltage profile 704 corresponds to battery cells having an anode active material containing graphite and silicon. Voltages profile 704 is lower than voltage profile 702, falls at a faster rate than voltage profile 702, and also falls precipitously at an SoC of approximately 6% SoC. Voltage profile 706 corresponds to battery cells having an anode active material containing graphite, silicon, and one or more additional Group (V) element(s). Voltage profile 706 parallels voltage profile 704 until reaching a 6% state of charge. The voltage at low SoC maintained at a plateau of 3V, thereby buffering the peak voltage (e.g., pulse discharge) in silicon-containing anode active materials.

An additional element or combination thereof, as described herein, is added to the Si anode, thereby improving battery cell power capability at low SoC. As result, the peak power performance improved at lower (less than 20%) SoC, thereby delaying early shutdown.

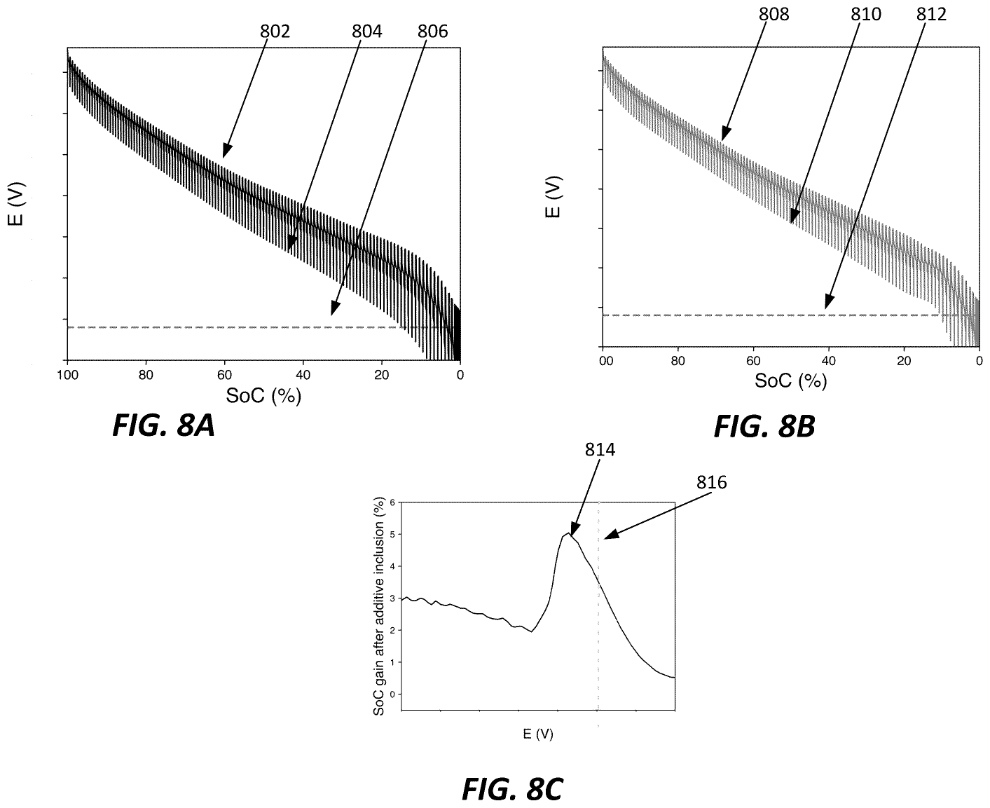

FIG. 8A depicts the E(V) as a function of SoC (%) for anodes lacking the additional element. The dashed line 806 depicts the shutdown voltage, which can vary for different devices. The base load is depicted at 802, while the pulse load 804 depicts voltage drops when there is an immediate power demand (e.g., a sudden CPU power request). The sudden power demand can cause the battery to shut down while there is still capacitance available. In FIG. 8A, shutdown occurs at 15% SoC. Poor power capability at low SoC in high Si batteries results in early shutdown during peak power device demand. By contrast, FIG. 8B depicts the E(V) as a function of SoC (%) for anodes including Si and the additional element. Dashed line 812 depicts the shutdown voltage, the base load curve is depicted at 808, and pulsed load 810 depicts voltage drops when there is an immediate power demand (e.g., a sudden CPU power request). In FIG. 8B, shutdown occurs at 6% SoC. FIG. 8C depicts the gain 814 between FIGS. 8B and 8A, as a function of E(V) and the higher % SoC at shutdown voltage 816. The increased SoC at shutdown voltage is depicted.

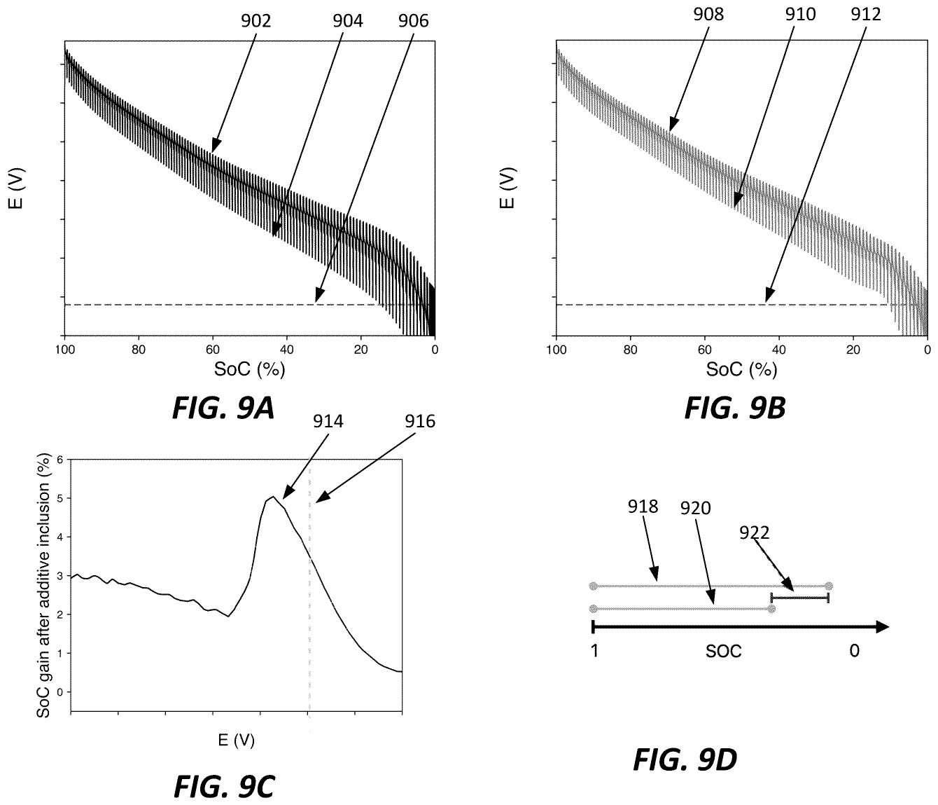

FIG. 9A depicts the E(V) as a function of SoC (%) for anodes lacking the additional element (in this case bismuth metal). The dashed line 906 depicts the shutdown voltage, which can vary for different devices. The base load is depicted at 902, while the pulse load 904 depicts voltage drops when there is an immediate power demand (e.g., a sudden CPU power request). The sudden power demand can cause the battery to shut down while there is still capacitance available. In FIG. 9A, shutdown occurs at 15% SoC. Poor power capability at low SoC in high Si batteries results in early shutdown during peak power device demand. By contrast, FIG. 9B depicts the E(V) as a function of SoC (%) for anodes including Si and the additional element bismuth metal. Dashed line 912 depicts the shutdown voltage, the base load curve is depicted at 908, and pulsed load 910 depicts voltage drops when there is an immediate power demand (e.g., a sudden CPU power request). In FIG. 9B, shutdown occurs at 6% SoC. FIG. 9C depicts the gain 914 between FIGS. 9B and 9A, as a function of E(V) and the higher % SoC at shutdown voltage 916. The increased SoC at shutdown voltage is depicted.

FIG. 9D depicts a comparison of the SoC gain. SoC 918 represents the full capacity of the battery. Conventional Si anode lacking the additional element is depicted by SoC 920. The SoC gain 922 is made possible by inclusion of the additional element as described herein.

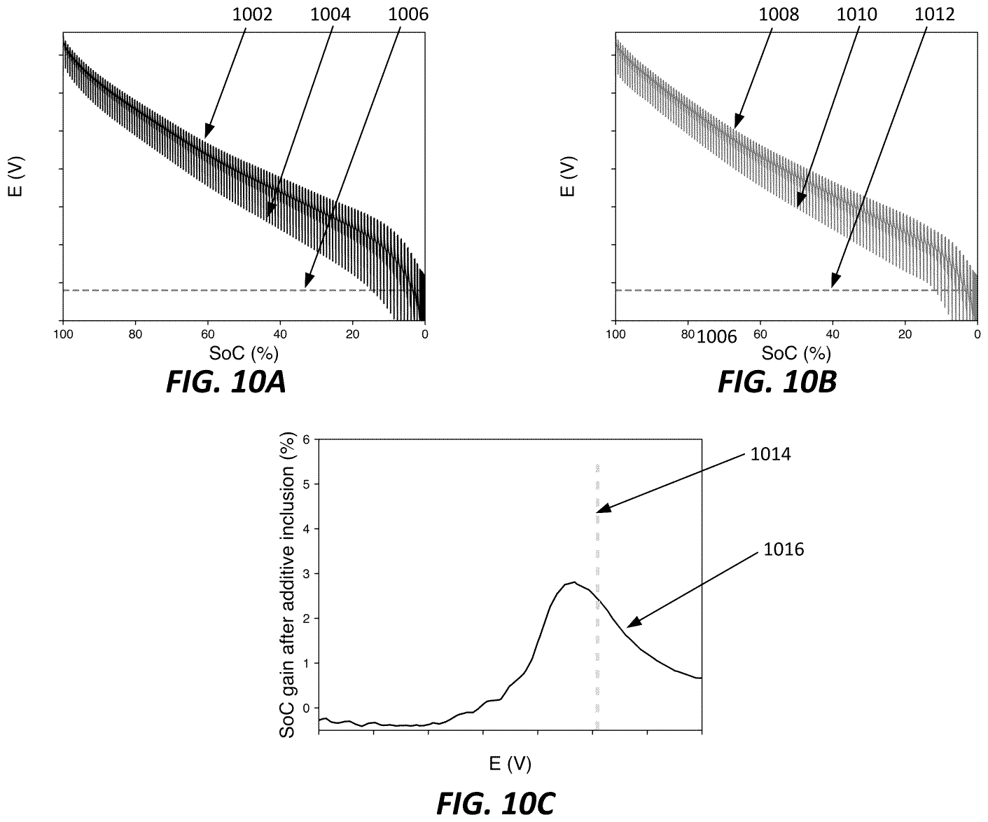

FIG. 10A depicts the E(V) as a function of SoC (%) for anodes lacking the additional element (in this case bismuth in the form bismuth oxide). The dashed line 1006 depicts the shutdown voltage, which can vary for different devices. The base load is depicted at 1002, while the pulse load 1004 depicts voltage drops when there is an immediate power demand (e.g., a sudden CPU power request). The sudden power demand can cause the battery to shut down while there is still capacitance available. In FIG. 10A, shutdown occurs at 15% SoC. Poor power capability at low SoC in high Si batteries results in early shutdown during peak power device demand. By contrast, FIG. 10B depicts the E(V) as a function of SoC (%) for anodes including Si and the additional element bismuth oxide. Dashed line 1012 depicts the shutdown voltage, the base load curve is depicted at 1008, and pulsed load 1010 depicts voltage drops when there is an immediate power demand (e.g., a sudden CPU power request). In FIG. 10B, shutdown occurs at 6% SoC. FIG. 10C depicts the gain 1014 between FIGS. 10B and 10A, as a function of E(V) and the higher % SoC at shutdown voltage 1016. The increased SoC at shutdown voltage is depicted.

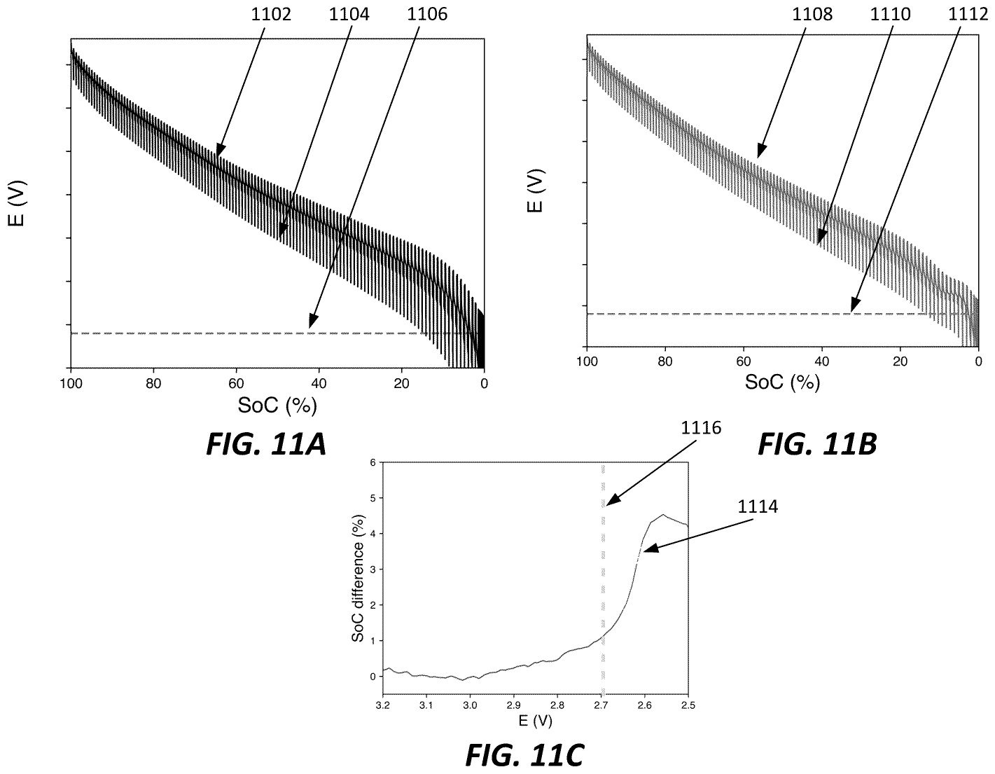

FIG. 11A depicts the E(V) as a function of SoC (%) for anodes lacking the additional element (in this case antimony). The dashed line 1106 depicts the shutdown voltage, which can vary for different devices. The base load is depicted at 1102, while the pulse load 1104 depicts voltage drops when there is an immediate power demand (e.g., a sudden CPU power request). The sudden power demand can cause the battery to shut down while there is still capacitance available. In FIG. 11A, shutdown occurs at 17% SoC. Poor power capability at low SoC in high Si batteries results in early shutdown during peak power device demand. By contrast, FIG. 11B depicts the E(V) as a function of SoC (%) for anodes including Si and the additional element antimony. Dashed line 1112 depicts the shutdown voltage, the base load curve is depicted at 1108, and pulsed load 1110 depicts voltage drops when there is an immediate power demand (e.g., a sudden CPU power request). In FIG. 11B, shutdown occurs at 10% SoC. FIG. 11C depicts the gain 1114 between FIGS. 11B and 11A, as a function of E(V) and the higher % SoC at shutdown voltage 1116. The increased SoC at shutdown voltage is depicted.

Turning to additional battery cell components, any cathode active material known in the art can be used in compositions, battery cells, and methods described herein. The cathode active material can be any material described in, for example, Ser. No. 14/206,654, 15/458,604, 15/458,612, 15/709,961, 15/710,540, 15/804,186, 16/531,883, 16/529,545, 16/999,307, 16/999,328, 16/999,265, each of which is incorporated herein by reference in its entirety.

In some variations, the cathode active material is a layered lithium transition metal oxide (LiₓM_{y}O_{z}, M=transition metal element, e.g., Ni, Mn, and Co). Layered lithium transition metal oxides can have compact structures and consequentially high packing densities, high specific volumetric capacity, stable charge/discharge voltages and comparatively good cyclability.

In some further variations, cathode active material includes a compound represented by Formula (I):

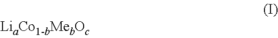

wherein
Me is selected from Na, Si, S, Al, K, V, Cr, Fe, Cu, Zn, Mn, Ni, Zr, La, Ce, Y, Mo, Sn, Ag, Nb, Nu, Ca, Ti, Mg, and a combination thereof;

$$0.95 \leq a \leq 1.05 ;$$

$$0 < b \leq 0.5 ; and$$

$$1.95 \leq c \leq 2.05 .$$

In some variations, where Me is a single element selected from Na, Si, S, Al, K, V, Cr, Fe, Cu, Zn, Mn, Ni, Zr, La, Ce, Y, Mo, Sn, Ag, Nb, Nu, Ca, Ti, and Mg, then 0<b≤0.15.

In further variations, Me is more than one element and each separate element present in b is less than or equal to 0.10.

In still further variations, Me is selected from Al, Mn, Ni, Zr, La, Ce, Y, Mo, Sn, Ag, Nb, Ca, Ti, and Mg. The amounts of any element or elements of Me, or selected groups of Me, can be combined with the amount of each element or elements in any combination described herein.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). However, other microporous polymer membranes or non-woven fabric mats are possible (e.g., gel polymer electrolytes).

In general, separators represent structures in a battery, such as interposed layers that prevent physical contact of cathodes and anodes while allowing ions to transport therebetween. Separators are formed of materials having pores that provide channels for ion transport, which may include absorbing an electrolyte fluid that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

Any electrolyte known in the art may be used in the battery cells. In some non-limiting examples, electrolytes can include those described in U.S. Patent Publications US 2022/0407112, US 2022/0407111, US2023/0011274, and US2023/0017642, each of which is incorporated herein by reference in its entirety.

The cathode current collector, cathode active material, anode current collector, anode active material, and separator may be any material known in the art. In some variations, the cathode current collector may be an aluminum foil, the anode current collector may be a copper foil.

Batteries can be combined in a battery pack in any configuration. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

The anodes, battery cells, and other materials described herein can be valuable in any battery containing device, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. An anode active material comprising:
carbon;
silicon; and
an additional element selected from P, As, Sb, Bi, Mg, Zn, Ag, Al, In, Ga, Ge, Sn, Pb, and a combination thereof.

2. The anode active material of claim 1, wherein the additional element is selected from P, As, Sb, Bi, and a combination thereof.

3. The anode active material of claim 1, wherein the additional element is selected from P, As, Sb, and Bi.

4. The anode active material of claim 1, wherein the ratio of carbon to silicon and the additional element is from 1:9 to 9:1 by volume.

5. The anode active material of claim 1, wherein the ratio of carbon to silicon and the additional element is from 5:5 to 7:3 by volume.

6. The anode active material of claim 1, wherein the amount of carbon is less than or equal to 90 wt % of the total anode active material.

7. The anode active material of claim 1, wherein the amount of carbon is than or equal to 85 wt % of the total anode active material.

8. The anode active material of claim 1, wherein the amount of silicon is at least 7 wt % of the total anode active material.

9. The anode active material of claim 1, wherein the amount of silicon is at least 10 wt % of the total anode active material.

10. The anode active material of claim 1, wherein the ratio of silicon to the additional element is from 1:9 to 9:1 by volume.

11. The anode active material of claim 1, wherein the ratio of silicon to the additional element is from 7:3 to 9:1 by volume.

12. The anode active material of claim 1, wherein the ratio of silicon to the additional element is less than 6:4 by volume.

13. The anode active material of claim 1, wherein the anode active material comprises a first population of particles having a first average diameter D50 and a second population of particles having a second average diameter D50.

14. The anode active material of claim 13, wherein the first average diameter D50 is from 1 micron to 100 microns.

15. The anode active material of claim 13, wherein the first average diameter D50 is from 8 microns to 10 microns.

16. The anode active material of claim 13, wherein the second average diameter D50 is from one eighth to one half of the first average diameter D50.

17. The anode active material of claim 13, wherein the second average diameter D50 is from one fourth to one third of the first average diameter D50.

18. An anode active material comprising:
carbon;
silicon;
a first additional element selected from P, As, Sb, Bi, Mg, Zn, Ag, Al, In, Ga, Ge, Sn, Pb, and a combination thereof; and
a second additional element selected from W, V, Ti, Nb, Fe, P, and a combination thereof.

19. The anode active material of claim 18, wherein the ratio of the first additional element to the second additional element is from 1:9 to 9:1 by volume.

20. A battery cell comprising:
a cathode and an anode;
the cathode comprising a cathode active material disposed on a cathode current collector; and
the anode comprising the anode active material of claim 1 disposed on an anode current collector.
